(19) United States
(12) Patent Application Publication
(10) Pub. No.: US 2026/0027920 A1
(43) Pub. Date: Jan. 29, 2026

(54) AUTOMOTIVE ELECTRICAL GENERATOR ELECTRIC VEHICLE PLATFORM

(71) Applicant: Eric Jason Crews, Blacksburg, VA (US)

(72) Inventor: Eric Jason Crews, Blacksburg, VA (US)

(21) Appl. No.: 18/783,827

(22) Filed: Jul. 25, 2024

(51) Int. Cl. B60L 50/90

(52) U.S. Cl. CPC B60L 50/90

(57) ABSTRACT

An automotive electrical generator electric vehicle platform. The platform includes an on-board electricity generator operative to be motivated by a hydraulic pressure and a pneumatic pressure to provide on-demand baug resistant electricity production. The hydraulic pressure is imparted by a hydraulic impeller operatively associated with the on-board electricity generator. The pneumatic pressure is imparted by a pneumatic impeller operatively associated with a pulley drive system configured with a counter tilt gear incline ratio.

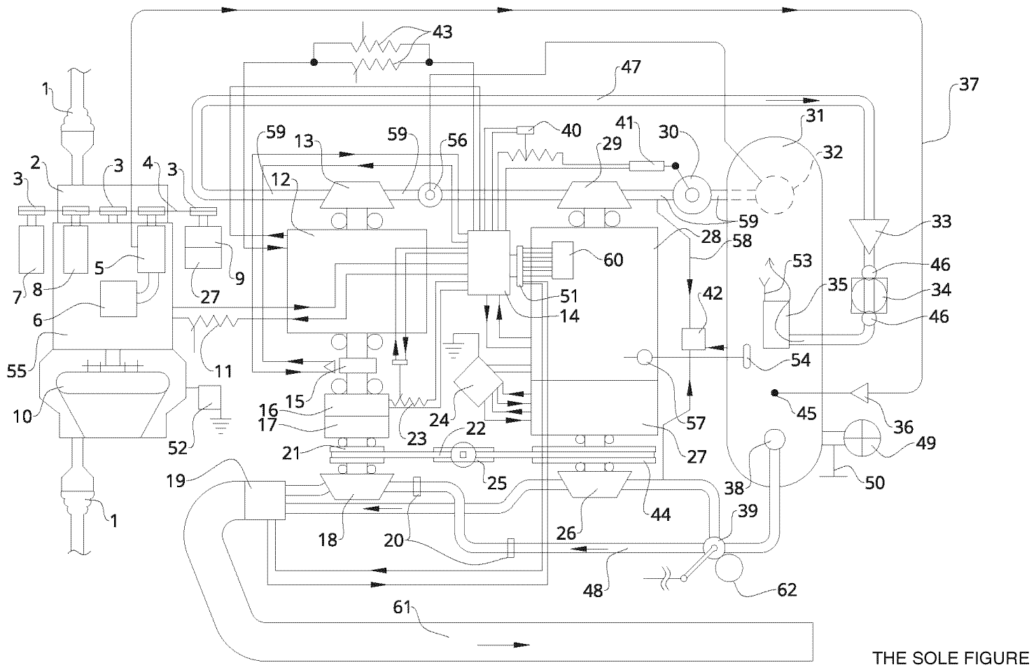

### BACKGROUND OF THE INVENTION

The present invention relates to electrical generation systems and, more particularly, to an automotive electrical generator electric vehicle platform.

In the years and decades to come oil will become exceedingly expensive as the oil was not grown for industrial use but rather harvested from Earth's deposits. So many automobile manufacturing companies have built into their business model a less refined product for more money—i.e., “built-in obsolescence”. Correct engineering also accommodates ease of maintenance. What we've been sold is residual payment and an inclined cost of repair upon outdated technology. Sometimes superior engineering is simpler. Old systems are failing and so many corners are cut in the scope of the total process involving compromising safety for increased miles per gallon affecting so many.

Currently, electric vehicles (EV) that use electricity storage batteries have problems with the dearth of charging stations to plug into and recharge. Furthermore, electricity storage batteries of electric vehicles can catch fire, wherein the fire can be more difficult to extinguish than fires in gas-powered cars. They can burn hotter, up to 5,000° F., and can reignite days or weeks after they seem to be out.

And so, because EV market vehicles require electrical charging and have limited range their presence along does not correct the infrastructure load demand for transportation when peak oil affects the commerce structure. Put another way, peak oil is a factor for internal combustion engine systems and electric plug-in vehicles have limited range.

As can be seen, there is a need for an automotive electrical generator electric vehicle platform, enabling unprecedented range for an electric vehicle and is less of a fire hazard as no fuel is used.

### SUMMARY OF THE INVENTION

The vehicle platform embodied in the present invention solves the above-mentioned problems by utilizing an on-board electricity generator motivated by two types of pressure “hydraulic fluid” and pneumatic pressure to provide “baug resistant” electricity production on demand, thereby enabling a vehicle that surpasses the service parameter of the internal combustion engine system as well as any other electric vehicle on the market, and solves the problem of having to electrically charge an electric vehicle as the automobile required no battery.

The following design system is a “draft accelerator” incorporating an “active” electric power plant using two types of pressure to then “continually” produce electricity for an electric automobile. The system uses hydraulic fluid (e.g., silicone oil) and pneumatic (“air”) pressure to motivate the power plant. It is important to understand the system does not burn oil. The system replaces the air pressure automatically.

The above design will also be able assist in clean air processing of internal combustion engine systems speeding the environmental clean-up until conversion to these types of systems becomes the predominant vehicle motor platform.

In one aspect of the present invention, automotive electrical generator electric vehicle platform having an on-board electricity generator operative to be motivated by a hydraulic pressure and a pneumatic pressure to provide on-demand baug resistant electricity production.

In another aspect of the present invention, the automotive electrical generator electric vehicle platform further includes wherein the hydraulic pressure results, in part, from a working oil of the automotive electrical generator electric vehicle platform, the working oil fluidly coupled to a hydraulic impeller, and wherein the hydraulic impeller is operatively associated with (a) the on-board electricity generator via a drive unit and (b) one or more magneto generators electrically connected through magnetism to on-board electricity generator to electrically empower the on-board electricity generator, wherein the pneumatic pressure results, in part, from a pneumatic impeller comprising a pulley drive system operative to impart rotation to the drive unit, and wherein the pulley drive system is configured with a counter tilted gear ratio.

These and other features, aspects and advantages of the present invention will become better understood with reference to the following drawings, description and claims.

### BRIEF DESCRIPTION OF THE DRAWINGS

The sole figure is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Referring now to the sole Figure, the present invention may include an electric vehicle having the following systemic components:
1. Drive shaft cup.
2. Automotive automatic transmission rotated by a main electric automotive motor 55.
3. Pulley and drive belt system, operatively associated with a main electric automotive motor 55, is configured to cause rotation for an air pump 5, a dual power steering pump and power brake pump 7, an air conditioner compressor 8, an alternator 9, wherein the rotational input torque is imparted by the pulley upon extending drive shaft from the main electric automotive motor 55 with tandem rotation with the armature of the main electric automotive motor 55.
4. Drive belt.
5. Air pump (contains electric clutch).
6. Air filter.
7. Power steering pump and power brake pump (a dual pump component) with unit failure crossover plumbing and a fault indicator sensor to illuminate upon the dashboard warning the driver of low fluid in either of the pumps.
8. Air conditioner compressor (contains electric clutch).
9. Alternator, 12V or equivalent.
10. Torque converter.
11. A throttle of the main electric motor 55, wherein the throttle may include a first potentiometer (or other variable resistor) and a dual coil spring (whose retention is set to the zero-output electricity position) or equivalent is operative in tandem with a second potentiometer 43 to cause a separate electric motor 12 to accelerate a load compensator, in turn making a main high voltage generator 28 accelerate, and thereby producing increased levels of electricity to then be applied to the main electric motor 55.
12. Electric motor (“advancer electric motor”)-electrical power to the unit compensates for the inclined resistance encountered by the magnetic field within the main high voltage generator when increased vehicle speed is incurred by the electrification of the main electric automotive motor 55, whereby electrical load compensation makes the generator “baug” resistant.

The applied magnetic pressure from the electric motor 12 may then cause advancement of the system, factored atop the drive belt pulley incline and “hydraulic draft” (fluid suction) compounding oil velocity rate. The oil pressure traversing across the hydraulic impeller causes higher rotation in the oil pump.

The electric “advancer” motor 12 would then effectively produce higher motor rotation capacity than a 10 horsepower (HP) electric motor. The “counter tilted” gear incline (ratio gear set and drive belt and pulley drive system), effectively is then increasing the rotational rate (RPM) of the motor then advancing the “launch” point of “magnetic pressure” causing increased electric motor speed at the HP rating.
13. Hydraulic pump.
14. Logic processing “systems mapping” electronic system speed control electronic circuit “box” contains water inundation “all stop” cut off safety switch sensor so that if the car encounters high water the generator will shut off.
15. RPM sensor.
16. A “counter tilt” electric motor tandem rotating with the high side of a ratio gear 17, which is configured to counter act upon the gear sets mechanical resistance. The unit also contains an electrical “drag” function used when shutting off the system to act as an electromagnetic field brake system to then slow down the total assembly's rotation.
17. Ratio gear set at 1:10 input rotation tandem rotated by a pneumatic impeller 18 (via its internal pneumatic impeller “wheel” and pulley 21 union tandem) via drive shaft. The piston type radial air impeller is tandem rotating with the receiving pulley 21 then the input rotation torque for the 1:10 gear is set. The ratio gear set has an output rotation tandem with an armature of the “counter tilt” electric motor tandem 16 that also is tandem with armature of the electric “advancer” motor 12 and the hydraulic pump internal “pump wheel” of the hydraulic pump 13.
18. Pneumatic impeller (piston type impeller) “rotary type” impeller contains electric clutch hydraulic locking functionality movable between a disengaged position and an engaged position. The internal clutch system then actuated “throw out” type weighted pressure plate and secured via a “lock out” solenoid. The solenoid is connected via wire to the systems logic processing system/mapping control electronics 14 via a multi wire connector 51, to then cause automatic functioning of the clutch.

The internal clutch will then be in the engaged position at “Start Up” and dis-engaged position when the system is in the “run” mode. The clutch system upon shutting the total system down, will then be returned to the engaged position for subsequent system “re-start”.
19. Exhaust air filter (may be augmented with an electric resistance heating element to then activate a catalytic converter to process external internal combustion engine automotive exhaust).
20. Pneumatic flow pipe coupling.
21. Pulley, in some embodiments approximately four inches in diameter.
22. Drive belt
23. Counter tilt electric motor variable resistor/circuit-controlled potentiometer.
24. Voltage regulator.
25. Tension pulley configured to adjust the drive belt tension.
26. Pneumatic impeller (centrifugal type) configurable as an air pump when the air pressure from the dual component pressure tank is shut off then pulling external “air” from the environment via base intake air filter upon a pneumatic “start valve” 39.
27. Magneto generator (permanent magnet generator) configured to feed electricity to the stator/field coil of a main high voltage generator 28 providing an internal commutator (e.g., “roller wheel contact brushes”). The magneto generator 27 then tandem rotating with the alternator 9, then circuit routed to also be able to “electrify” the field coil of the main electricity generator 28 acting as a secondary base root source of electrical current.

This is required to compensate for possible voltage regulator failure, then keeping the total system able to function. The output electrical current from the alternator tandem mount magneto generator 27 may be voltage regulated and directed to the engine's system logic mapping circuit board 14 to be applied to other vehicle functions as well.

The generator system contains two magneto generators 27 to increase the service parameter of the generator a safety redundant feature for contiguous service
28. Main high voltage generator contains roller “wheel brushes” redundant offset failure rate indicates upon the car's dashboard when failure has occurred of if a fault is detected—i.e., if the current transmission has encountered failure. The contact “brush” roller wheel contact brushes are then of high hardness with sealed lubricated bearings.
29. Hydraulic impeller “rotates by the hydraulic draft effect of a pneumatically pressurized oil” and causes the generator armature and magneto's armature to rotate by hydraulic suction and by pneumatically pressurized oil. The hydraulic impeller is connected, via a drive unit, such as a drive shaft, to the armature of the generator and commutator within the main high voltage generator 28 and magneto's armature/commutator 27. The hydraulic impeller is also rotating, via the internal drive shaft, the large pulley 44 and the internal pneumatic impeller “wheel” of the pneumatic impeller 26.
30. Oil flow rate regulator valve-redundant solenoid control-coil spring dampener “opens” under (by) high suction-solenoid “pushes” the valve closed “restricts” oil flow. By way of illustrations, the term “high” is understood to include suction produced from higher rotation of the hydraulic pump, which in turn causes the hydraulic impeller to increase because one cannot “stretch” a fluid in confinement of a rigid flow pipe. The valves inner “tumbler” then allowing interval/gradian of oil flow does not completely close
31. Dual component pressure storage tank nonflammable non-electrically conductive hydraulic oil under pneumatic (air) pressure, whereby air pressure causes oil pressure.
32. Oil drain.
33. One way valve (oil/hydraulic fluid).
34. Oil filter (diaphragm type) so that the oil is directed thru the filter for the first ten seconds of oil flow when starting the system so that the coil spring tension valve plate diaphragm will open due to oil pressure and velocity of oil, thereby allowing the diaphragm plate to open flow of oil not to then be encumbered by the oil filter.
35. Oil return coupling.
36. One way valve (pneumatic) air pressure re-pressurization flow tube.
37. Pneumatic pressure pipe/tubing/hose.
38. Pneumatic fitting.
39. Pneumatic “start valve” (is also a “breather valve” so that when the system is in the “run” mode the air from the combined component pressure storage tank is then shut off and the valve “breathes” via an air intake air filter retained upon its base.
40. Circuit controlled variable resistor/circuit-controlled potentiometer.
41. Solenoid.
42. Plasma box (controls and dissipates unwanted system static electricity/static electricity control acts as an electricity electrical ground).
43. Second potentiometer/variable resistor (may work in unison with the system “throttle” 11) to cause “baug” resistant power ban incline.
44. Large pulley, e.g., approximately twelve inches in diameter.
45. Pneumatic return coupling/pipe fitting.
46. Flow system shut off valve.
47. Oil flow pipe.
48. Pneumatic high pressure flow pipe/pressure hose.
49. Over pressure max pressure system safety valve (vents pneumatic over pressure) and may contain one-way manual pneumatic fill valve, thereby allowing for manual pneumatic pressurization for initial start-up/operating pneumatic pressure.
50. Pneumatic pressure sensor controls air “re-pack” air pump 5, thereby keeping the pneumatic pressure full in the dual component pressure storage tank.
51. Multi wire “ribbon wire” bus connector wire connector instrumentation wire connector.
52. Plasma box (controls and dissipates unwanted system static electricity/static electricity control acts as an electricity electrical ground).
53. Manual pneumatic fill valve one way fill valve.
54. Oil fill pressure cap with wire security retainer clip. The threaded screw on cap then is also with a pneumatic “decompression” valve used when changing the pressure tank's oil. The pressure rated screw cap also contains a redundant over pressure pneumatic pressure safety valve rated at the system operating pneumatic pressure to allow for decompressing of pneumatic pressure (vents “over pressure”).
55. Main electric automotive motor (rotates the torque converter and automatic automotive transmission).
56. Oil inlet safety valve/coil spring provides run away effect prevention dampener valve (ensures the structural integrity of the flow pipe), and flow cycle “electric actuation valve”, that is configured to regulate the available oil to the hydraulic pump 13. The oil inlet safety valve/coil spring 56 is configured to “control” the system speed by direction of oil pressure then by-passing the hydraulic draft impeller 29. The logic circuit board 14 is configured to use the RPM sensor 15 sensed data to set the valve position via electronic solenoid 41 to cause the system “run” settings to operate correctly. In short, the oil inlet safety valve 56 is operative to prevent pipe implosion or system speed run away effect.

The “electric valve assembly” flow valve is then retained by internal coil spring to the oil flow “by-pass position” to allow valve failure to then default to the “open flow” position “by-passing” the hydraulic impeller 29, critical for safety.

Electrification of the said valve enabling incremental “adjustable current level” and oil pressure/volume flow variance, which is determined to obtain system speed, “base idle”, referencing the drive line's assemblies' RPM sensor 15, which in turn extrapolates the current level required by the electronic circuits within the logic circuit board 14.
57. Manual fill valve for both air pressure and oil air pressure causes oil pressure within the pressure tank.
58. Ground wire.
59. Oil pipe.
60. Instrumentation control and system gauge display panel.
61. Tail exhaust pipe.
62. “Run” cycle intake air filter.

The present invention only displaces pneumatic pressure at “startup” with the ability to replace the air pressure automatically. The air pressure is replaced by the system's “on-board” air pump. The design cycles hydraulic pressure to produce electricity. It does not burn the oil, and so the “working fluid” is a “non-electrically conductive”, “nonflammable oil” (e.g., silicone oil or other suitable nonflammable hydraulic fluid). The design enables an unprecedented range for electric vehicles with “on demand” service.

The system embodied by the present invention is an “active” electrical generator (an A.E.G. motor) automotive motor platform that allows for an unprecedented range on-demand service 24/7. The design uses sealed generator/magneto and motor system to control low level ozone. The system uses a drive belt 22 but may be made with a vented, “oil encased” lubrication system with a chain and sprocket system extends the lifespan of the pulleys 21, 25, and 44, thereby enabling sprockets, drive belt 22 and a drive chain within a vented oil lubricated encasement with threaded magnetic drain plug.

The design system only dissipates the pneumatic pressure at “startup”—i.e., the discharge of air pressure from a (dual component) pressure storage tank. When the design is in the run “mode” the air pressure from the combined component pressure storage tank may be shut off. This reduces fatigue upon the system's air pump only working for a short time to replenish the air pressure in the dual component pressure storage tank 31.

When the hydraulic pump 13 is at high velocity the oil traversing across the hydraulic impeller 29 is then causing the main high voltage generator to accelerate. The large pulley 44, in tandem rotation with the hydraulic impeller 29, enables the receiving pulley 21, geared at a greater rate of rotation, to create a compound incline in rate of rotation. In other words, the large pulley 44 causes the receiving pulley 21 to rotate at a greater rate yielding higher rotational speed of the oil pump 13.

The basal (base) pneumatic pressure within the combined component/dual component pressure storage tank 31 is then greater slightly to include the required “start pneumatic pressure displacement” requirement added to the generators “run” pounds per square inch (PSI) pressure requirement. The “run” PSI then maintained by the air pressure sensor referencing the dual component air pressure within the dual component pressure storage tank 31, thereby actuating, via electronic circuit, the electric clutch in the system air pump 5.

When the oil is returning to the combined component pressure storage tank, the return coupling is then atop the pressure tank so that the oil is injecting into the decreasing pneumatic pressure. The oil returns faster than the discharge due to the oil being displaced into the hydraulic impeller with the velocity increased by the hydraulic pump. The return of oil at a greater rate will in turn increase the pneumatic pressure allowing for a greater oil pressure displacement pressure and provide more “work” capacity as the system speeds up.

It is important to understand this works due to the “state/phase” of matter. Air pressure “flexes” and hydraulic oil acts as a “solid”. In addition, the “draft effect” is incurred using a “suction effect”—i.e., “pulling” hydraulic fluid in confinement to then incur a system speed incline in tandem with a “counter tilted” speed incline gear set while advancing the application point of magnetic “pressure” via electric motor to then have the magnetic “pressure” (electricity inducing magnetism) then to cause the horsepower of the electric motor applied atop the fluid velocity rate.

The dual component pressure tank 31 (e.g., air pressure atop oil causing oil pressure) pressure tank then will only allow safe levels of pneumatic pressure as the max pressure safety vent will then allow for decompression of pneumatic pressure should the level become too high. The over pressure/max pressure safety valve 49 will also include a fault sensor to indicate that the valve is working correctly—a critical component such as this will also require a safety circuit to then cause a system “all stop” function should the safety valve 49 become encumbered. The “all stop” function then will close the valve 30 and reduce the electricity feed current to the potentiometer 23 via the electric circuit.

The magneto then energizes the stator/field coil of the generator post voltage regulator to then produce electricity by the hydraulic pump implementing the draft effect—i.e., pulling pressurized oil in confinement (“within the pipe”), allowing valve 30 to open and producing a syringe effect drafting pressurized fluid across the hydraulic impeller 29, by the hydraulic pump 13, to accelerate the generator assembly while the drive belt side of the system then also advances the hydraulic pump to greater rotational rate upon the adjacent assembly causing the “work transference fluid” (silicone oil) to then return to the dual component pressure storage tank faster than the hydraulic fluid (silicone oil) is discharged. This produces sustained electricity production.

The “counter tilt” electric motor 16 then “zero's” the resistance in the ratio gear set, to then, with the counter tilt electric motor energized, cause a system speed incline and stable “idle” also causing the hydraulic pump to advance at greater rate. This allows for a percentile of the generated electricity to be reintroduced to the “counter tilt” electric motor tandem 16—i.e., from the generator 28 to the “advancer” electric motor 12—to cause sufficient levels of rotation for the generator's remainder output electricity to electrify the main electric motor 55 that propels the automobile via automotive automatic transmission.

The electricity producing power plant is electrically insulated from the chassis and its final encasement can be made waterproof (requires additional cooling coil from the car's air conditioning system inert sealed gas filled chamber—zero water vapor in system) so that even if encountering high flood the system will remain dry within the design encasement with the cooling coils then cooling the power system (electric motors and generators).

If a vented version of the final encasement is used the system will be able to heat dissipate by electric blower fan and thermostat but be a water safe design so that even if submerged in water the system will not cause the water to conductive electrically. The generator system and electric motor drive system final casing is then also with an inductance cage to prevent internal or external disruption by electro-magnetic pulse (EMP). The inductance cage shields sensitive electronics.

Automotive automatic transmission is also electrically insulated from the main electric drive motor. The system uses non electrically conductive motor mounts for the generator system and the electric motor automotive automatic transmission system. The drive shafts also contain an electricity insulator coupler to then prevent any stray electricity from reaching the drive shaft's exposed drive shaft cup.

The main electric motor, power plant (generator), and automotive transmission system are not electrically grounded to the chassis. There are two “plasma box” to harvest “recycle” any static electricity produced from the flow of pneumatic displacement or the motion of hydraulic oil (silicone oil) the plasma box then acting as an electrical ground also reporting to the system mapping electronics/control circuits 14. The plasma box is an “artificial electrical ground” that must dissipate any electrical inductance to prevent any electrical shock hazard.

It should be noted that the circles upon the drive shaft, connecting components, represent sealed lubricated bearings that stabilize the drive shaft's rotation.

It should also be noted that the air pressure hose-flow tube/pipe terminal—ends are then connected to the system valve/components with pressure rated couplings to assist in drive belt change ease of access. The oil piping flow system uses pressure rated metal pipe of stainless steel and the pneumatic hoses may be of pressure rated plastic or flex hose.

Stainless steel will also be the material selection of choice for all rotating high-speed components to reduce the chance of failure incident due to rust. High speed components may be contained within a shock casing to then mitigate the chance of manufacturing defect causing a projectile hazard.

All pressure fittings that join the flow pipes or connection pressure hoses then of stainless steel also. The flow pipes are then electrically insulated upon the exterior of the pipe and encased in a “shock casing” (impact shield) to reduce the chance of injury should the pipe become damaged or fails due to manufacturing defect.

It should also be noted that the system is able to scale according to the application then serving is unique function so the ratings for different applications regarding HP and electricity production output, will also then be adjusted in accordance. An electric automobile then requiring an electric drive motor 55 of approximately twenty HP and a generating capacity of forty kilowatts for a system such as this will allow the electric motors upon the high side of the ratio gear then to both be rated at ten HP equivalent.

In sum, the present invention works through pneumatic pressure that causes oil pressure and by the hydraulic draft effect of a pressurized fluid the hydraulic impeller causes higher drive line rate of rotation to advance the system producing on-demand electricity production to then be applied to the vehicles electric motor. Inductance cage shielded circuits motor electronic circuit mapping system governs the motor system as well as the generator system yet with manual shut off control.

The invention present invention is a stable power producer for the automotive industry, such as but not limited to food trucks, cars, semi-truck transport, and the like. Since vehicles using the present invention require no battery the manufacturing cost is then lowered thus reducing the final retail cost of the product or allowing for more crash safety at comparable cost, making the final product a more attractive purchase.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

1. An automotive electrical generator electric vehicle platform comprising:
a dual component pressure storage tank configured to cause, from a pneumatic pressure contained therein, a hydraulic pressure;
a motor configured to cause rotation for an air pump, wherein the air pump is operatively associated with the dual component pressure storage tank to replenish pneumatic pressure therein; and
an on-board electricity generator operative by the hydraulic pressure and the pneumatic pressure to provide on-demand baug resistant electricity production.

2. The automotive electrical generator electric vehicle platform of claim 1, wherein the hydraulic pressure urged by a working oil of the automotive electrical generator electric vehicle platform, the working oil fluidly coupled to a hydraulic impeller, and wherein the hydraulic impeller is operatively associated with (a) the on-board electricity generator via an initial dissipation of pneumatic pressure and (b) one or more magneto generators electrically connected through magnetism to on-board electricity generator to electrically empower the on-board electricity generator.

3. The automotive electrical generator electric vehicle platform of claim 2, wherein the pneumatic pressure is urged by a pneumatic impeller comprising a pulley drive system operative to impart the initial dissipation of pneumatic pressure.

4. The automotive electrical generator electric vehicle platform of claim 3, wherein the pulley drive system comprising a counter tilted electric motor tandem rotating with a high side of a ratio gear.
